(19) United States
(12) Patent Application Publication
(10) Pub. No.: US 2026/0028563 A1
(43) Pub. Date: Jan. 29, 2026

(54) LIQUOR SMOKING DEVICE

(71) Applicant: Taizhou Fenglu Technology Co., Ltd., Taizhou (CN)

(72) Inventor: Xianghua TANG, Taizhou (CN)

(73) Assignee: Taizhou Fenglu Technology Co., Ltd., Taizhou (CN)

(21) Appl. No.: 19/018,113

(22) Filed: Jan. 13, 2025

(30) Foreign Application Priority Data
Jul. 29, 2024 (CN) 202421810459.3

(51) Int. Cl. C12G 3/07

(52) U.S. Cl. CPC C12G 3/07

(57) ABSTRACT

A liquor smoking device includes a handheld part, a main body part and a movable part. The handheld part includes a handle and an ignition apparatus; the main body part and the handle are spaced apart from each other, a placing cavity is formed inside the main body part, a combustion chamber is formed in a middle part of the placing cavity, first vent holes communicating with the combustion chamber are formed in the side wall of the main body part, and a first smoke outlet communicating with the outside is formed in a bottom wall of the combustion chamber; the movable part is stably placed in the placing cavity, a front end of the movable part is integrally provided with an accommodating groove and a rear end is integrally provided with a push-and-pull member, and the movable part further includes a combustion groove.

### TECHNICAL FIELD

The present application relates to the field of liquor utensils, and in particular, to a liquor smoking device.

### BACKGROUND

In life, when alcoholic beverages need to be drunk, there are various types of white spirits and foreign liquor to choose from; particularly when drinking a cocktail or whiskey, people have a habit of smoking them before drinking. Different types of trees have their own wood fragrances, such as peach wood, oak wood, pine wood, and sandalwood, and such fragrances are blended into the smoke generated when the wood chips are burned; using the smoke to smoke the liquor in the glass will give the liquor a corresponding wood fragrance.

Chinese Patent Publication No. CN217826694U provides a beverage smoking device, including a smoking body and a smoking furnace. The smoking body is of a hollow chamber structure, the smoking furnace is provided on the top part of the smoking body, a smoking cavity is formed inside the smoking furnace, and the smoking cavity communicates with the hollow chamber of the smoking body. A smoking net is provided in the smoking cavity. A smoking cover is provided on the smoking body in a covering manner, and the smoking cover is covered and buckled on the top part of the smoking body in a matching manner. The cross-sections of the smoking body and the smoking cover are irregular shapes. The middle diameter of the smoking body is larger than the bottom diameter thereof, and the lower bottom surface of the middle part of the smoking body is of a planar structure. The center of the top ring of the smoking body extends and protrudes inwards to form a first ring platform. The center of the top ring of the smoking furnace extends and protrudes inwards to form a second ring platform, the second ring platform is provided with at least two lugs protruding outwards and spacing apart from each other, and the lugs abut against the top part of the smoking body. The bottom part of the smoking net is away from the bottom part of the smoking furnace.

However, the beverage smoking device does not have a handheld part, which is inconvenient to take and place, and at the same time, the smoking furnace is inconvenient to take out due to overheating after the fuel inside is burned.

### SUMMARY

Given the defects of the prior art, the present application aims to provide a liquor smoking device that is convenient to hold by hand and replace fuel.

The technical purpose of the present liquor smoking device is realized by the following technical solutions.

A liquor smoking device includes:
a handheld part, including a handle and an ignition apparatus, where the handle can be held by a hand, and the ignition apparatus can generate a flame;
a main body part, where the main body part and the handle are spaced apart from each other and provided below the ignition apparatus, a placing cavity is formed inside the main body part, the placing cavity is provided with an opening in a side wall of the main body part, a combustion chamber is formed in a middle part of the placing cavity, first vent holes communicating with the combustion chamber are formed in the side wall of the main body part, and a first smoke outlet communicating with the outside is formed in a bottom wall of the combustion chamber; and
a movable part, where the movable part can be stably placed in the placing cavity, a front end of the movable part is integrally provided with an accommodating groove penetrating through up and down, a rear end is integrally provided with a push-and-pull member for fingers to push and pull out, and a combustion groove made of a noncombustible material is further included, where the combustion groove is a U-shaped groove with an upper-end opening and provided with through holes in a bottom wall and a side wall, the combustion groove can disengage from the accommodating groove, the combustion groove contains wood chips and is placed in the accommodating groove, the push-and-pull member is pushed to place the movable part in the placing cavity, the combustion groove enters the combustion chamber, the ignition apparatus ignites the wood chips to generate smoke, the smoke is discharged to the outside through the first smoke outlet, the push-and-pull member is pulled to take out the movable part, and the burnt wood chips in the combustion groove can be replaced or the combustion groove with new wood chips is directly replaced with.

Further, the ignition apparatus includes a fuel bin provided in the handle, an ignition switch provided at a top part of the handheld part, and an ignition head provided directly above or obliquely above the combustion chamber, where the ignition head is connected to second vent holes communicating with the outside, the ignition switch is turned on, and the ignition head generates a flame to ignite wood chips in the combustion groove.

Further, the main body part, the accommodating groove, and the combustion groove all feature cylindrical contours.

Further, the push-and-pull member is a square groove formed by concaving a lower half part of an outer side surface of the movable part inwards, and a finger accommodating hole for accommodating fingers is formed upwards in an upper side wall of the square groove.

Further, the movable part and the main body part are both made of a wood material, and the combustion groove is made of an iron material.

Further, an outer shell part made of a metal material is further included, and the outer shell part accommodates the main body part and the handheld part without affecting the functions of the two.

Further, a first groove is formed on a surface of a bottom wall of the main body part and a surface of a bottom wall of the outer shell part on a same straight line, the first groove communicates the surface of the bottom wall of the main body part and the surface of the bottom wall of the outer shell part, and at least one first groove is formed.

Further, a base part is further included, where a top wall is provided at a top part of the base part, and the top wall can be attached to the bottom wall of the main body part and/or the bottom wall of the outer shell part, such that the liquor smoking device is stably and horizontally placed on a horizontal plane.

Further, a bent pipe of degree bending is provided in a middle part of the base part, the bent pipe is vertically provided with a smoke inlet protruding from the top wall, the bent pipe is horizontally provided with a second smoke outlet, and the smoke inlet can be inserted into the first smoke outlet, such that smoke in the combustion chamber redirects via the bent pipe and is discharged from the second smoke outlet.

Further, the base part is hollowed out, an edge of the top wall extends downwards to form a side wall, a notch is formed in the side wall, and the notch can accommodate a pipe to pass through and is connected to the first smoke outlet.

In summary, compared with the prior art, the present application has the following beneficial effects. The liquor smoking device can be conveniently taken, placed, and moved by holding the handle, the movable part is pushed in and taken out through the push-and-pull member, and the burnt wood chips in the combustion groove can be replaced without contacting the high-temperature combustion groove after combustion; or the movable part is inverted to pour out the whole high-temperature combustion groove, and then another combustion groove containing new wood chips is placed to replace with, which is convenient to use. Meanwhile, the wood chips in the combustion groove are directly ignited by the ignition apparatus provided on the handheld part, such that the steps of separately using a lighter, ignition gun, or the like to align and ignite are omitted, which is more efficient and convenient.

### BRIEF DESCRIPTION OF THE DRAWINGS

FIG. 1 is a first schematic diagram of an overall structure of an embodiment.

FIG. 2 is a second schematic diagram of an overall structure of an embodiment.

FIG. 3 is a schematic diagram showing a state where a movable part is drawn out.

FIG. 4 is a schematic exploded diagram of the movable part from depression and elevation angles.

FIG. 5 is a schematic cross-sectional diagram of an embodiment.

FIG. 6 is a schematic diagram of a combined structure of a first embodiment of a base.

FIG. 7 is a schematic diagram of a separate structure of the first embodiment of the base.

FIG. 8 is a schematic diagram of a combined structure of a second embodiment of the base.

FIG. 9 is a schematic diagram of a separate structure of the second embodiment of the base from depression and elevation angles.

FIG. 10 is a first exploded diagram of an outer shell part.

FIG. 11 is a second exploded diagram of the outer shell part.

### DETAILED DESCRIPTION OF THE EMBODIMENTS

In the description of the present application, it should be noted that the terms “upper”, “lower”, “inside”, “outside”, “front”, “rear”, and the like indicate orientations or positional relationships based on those shown in the accompanying drawings, which is merely for the convenience of describing the present application and simplifying the description, rather than indicating or implying that the apparatus or element referred to must have a specific orientation, be constructed and operated in the specific orientation, so it cannot be understood as a limitation to the present application.

The present application will be described in further detail with reference to the accompanying drawings.

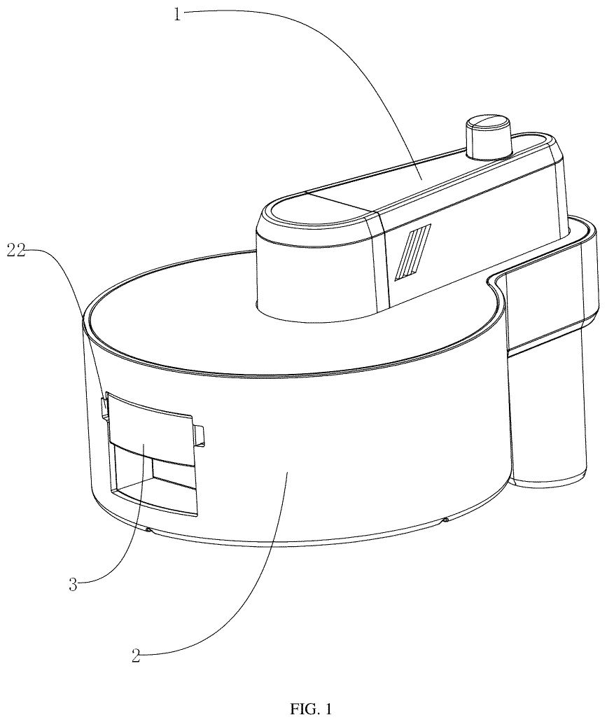

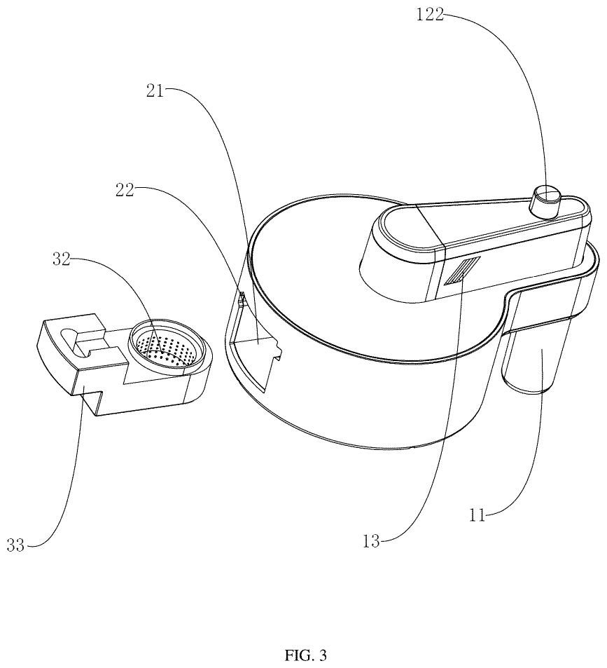

A liquor smoking device is provided. As shown in FIGS. 1 to 11, the liquor smoking device includes a handheld part 1, a main body part 2, and a movable part 3. The handheld part 1 includes a handle 11 and an ignition apparatus 12, where the handle 11 can be held by a hand, the ignition apparatus 12 can generate a flame, and the ignition apparatus 12 may adopt a common ignition gun, such as the ignition gun structures disclosed in Chinese Patent Publications CN202598589U and CN218409996U. The main body part 2 and the handle 11 are spaced apart from each other and provided below the ignition apparatus 12, a placing cavity 21 is formed inside the main body part 2, the placing cavity 21 is provided with an opening in the side wall of the main body part 2, a combustion chamber 23 is formed in the middle part of the placing cavity 21, first vent holes 22 communicating with the combustion chamber 23 are formed in the side wall of the main body part 2, the arrangement of the first vent holes 22 is to ensure that sufficient air can enter the combustion chamber 23 for combustion, a first smoke outlet 24 communicating with the outside is formed in the bottom wall of the combustion chamber 23, and the first smoke outlet 24 is preferably formed in the center of the bottom wall. The movable part 3 can be stably placed in the placing chamber 21; the front end of the movable part 3 is integrally provided with an accommodating groove 31 penetrating through up and down, and preferably, after the movable part 3 is placed, the center point of the accommodating groove 31 and the center of the first smoke outlet 24 are located on the same vertical straight line, and the rear end of the movable part 3 is integrally provided with a push-and-pull member 33 for fingers to push and pull out; a combustion groove 32 made of a noncombustible material is further included, the combustion groove 32 is a U-shaped groove with an upper-end opening and provided with through holes in the bottom wall and the side wall, and the combustion groove 32 can disengage from the accommodating groove 31.

Preferably, the main body part 2, the accommodating groove 31, and the combustion groove 32 all feature cylindrical contours. The combustion groove 32 is preferably made of an iron material; the sticker material is resistant to high temperature, such that the wood chips contained therein are not prone to burning the combustion groove out during combustion, and the combustion groove is not only durable but also has a low material cost. The movable part 3 and the main body part 2 are preferably made of a wood material, the wood material is slow in heat conduction, such that the heat is not easily transmitted through the movable part 3 and the main body part 2 after the combustion groove 32 is heated, and thus the hand is not scalded.

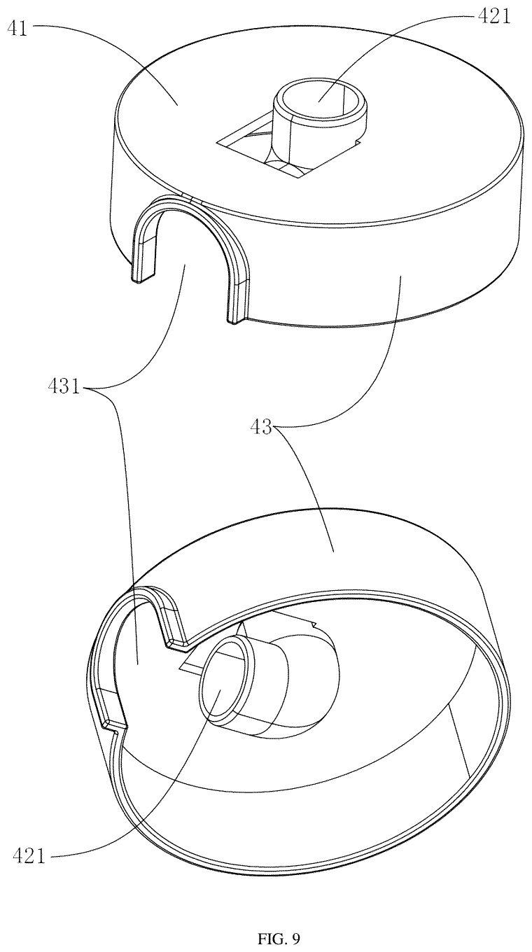

The combustion groove 32 contains wood chips and is placed in the accommodating groove 31, the push-and-pull member 33 is pushed to place the movable part 3 in the placing cavity 21, the combustion groove 32 enters the combustion chamber 23, the ignition apparatus 12 ignites the wood chips to generate smoke, and the smoke is discharged to the outside through the first smoke outlet 24. The handle 11 is held by a hand to directly place the liquor smoking device on the rim of a glass containing liquor, and in this case, the smoke from the first smoke outlet 24 can directly enter the glass downwards, thereby smoking the liquor in the glass; if the smoke is not enough, the push-and-pull member 33 can be pulled to take out the movable part 3, the burnt wood chips in the combustion groove 32 are replaced or the combustion groove 32 with new wood chips is directly replaced with, and ignition is performed again for smoking. To further reduce the flame in the combustion groove 32 burning the inner walls of the combustion chamber 23, as shown in FIG. 9, the inner walls of the upper and lower sides of the combustion chamber 23 may be preferably provided at a certain distance from the combustion chamber 32.

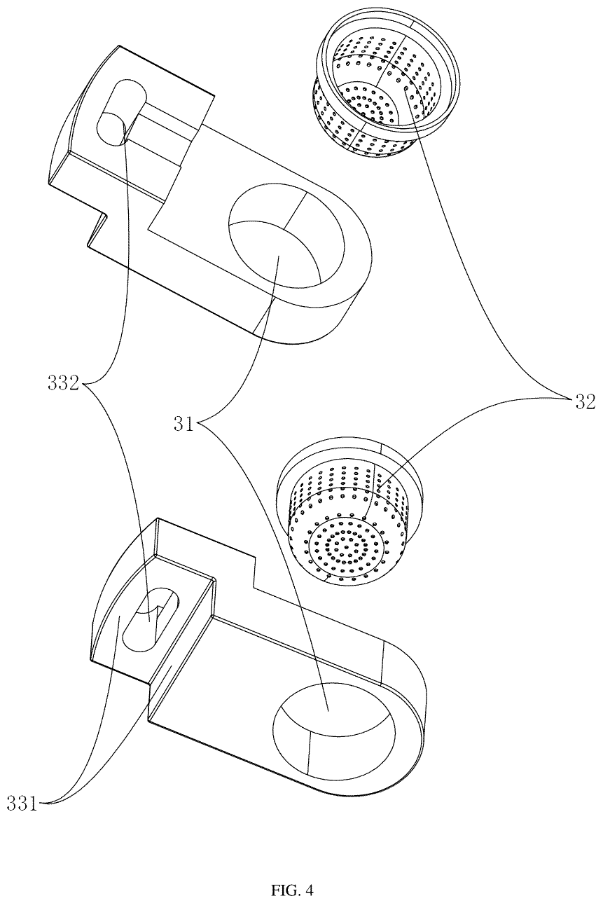

The push-and-pull member 33 may adopt a common drawer, wardrobe groove, or handle structure, or may be provided as follows. As shown in FIG. 4, a square groove 331 is formed by concaving the lower half part of the outer side surface of the movable part 3 inwards, and a finger accommodating hole 332 for accommodating fingers is formed upwards in the upper side wall of the square groove 331. When the push-and-pull member is pushed or pulled, the thumb presses the upper half part of the outer side surface of the push-and-pull member 33, the index finger and other fingers extend upwards into the finger accommodating hole 332, and at the same time, the back of the index finger and other finger abuts against the vertical side wall of the square groove 331, such that whether to push or pull the push-and-pull member 33, or move the push-and-pull member after being taken out, the minimum force can be used, and it is easy and stable to use.

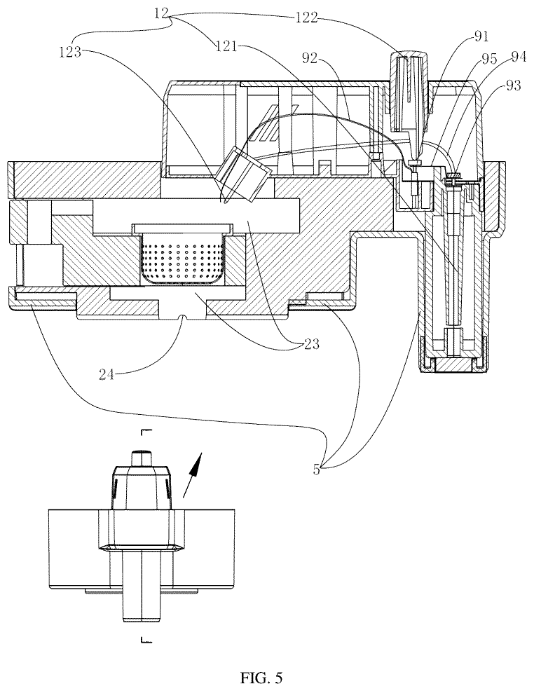

As shown in FIG. 5, in this embodiment, the ignition apparatus 12 includes a fuel bin 121, containing liquefied butane therein, provided in the handle 11, an ignition switch 122 provided at the top part of the handheld part 1, and an ignition head 123 provided directly above or obliquely above the combustion chamber 23. The ignition head 123 is connected to second vent holes 13 communicating with the outside, and the second vent holes 13 provide necessary air for ignition of the ignition head; the ignition switch 122 is turned on, and the ignition head 123 generates a flame to ignite wood chips in the combustion groove 32; the arrangement of the fuel bin 121 in the handle 11 makes full use of the space, the handle 11 is held by four fingers, and the thumb can press the ignition switch 122, which is convenient to use. The structure of the fuel bin 121, the ignition switch 122, and the ignition head 123 may be connected by adopting a method in the prior art such as Chinese Patent Publications CN202598589U and CN218409996U, or may adopt a structure as shown in FIG. 5. That is, the ignition switch 122 is provided as a button, and an electric shock device 91 is provided abutting against the lower part of the button. The current generated by the electric shock device 91 is transmitted through a wire 92, the electric shock end of the wire 92 is provided near the ignition head 123, a fuel valve 93 is provided above the fuel bin 121, and the fuel valve 93 is closed in the default state; a fuel pipe 94 is provided, one end of the fuel pipe 94 is connected to the fuel valve 93, the other end is connected to the ignition head 123, and the electric shock device 91 and the fuel valve 93 are connected to a lever piece 95. The ignition switch 122 is pressed, the button moves downwards to press against the electric shock device 91 to generate a current, the top cover of the electric shock device 91 moves downwards and drives the top cover of the fuel valve 93 to move upwards through the lever piece 95 to open the fuel valve 93, and the fuel in the fuel bin 121 is delivered to the ignition head 123 through the fuel pipe 94; after the ignition head 123 ejects the atomized fuel, a burning flame is generated under the action of the current of the wire 92, thereby igniting the wood chips in the combustion groove 32.

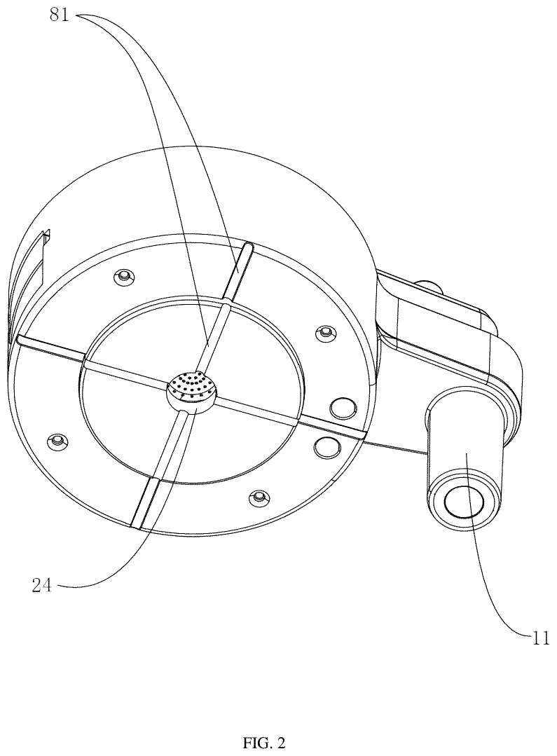

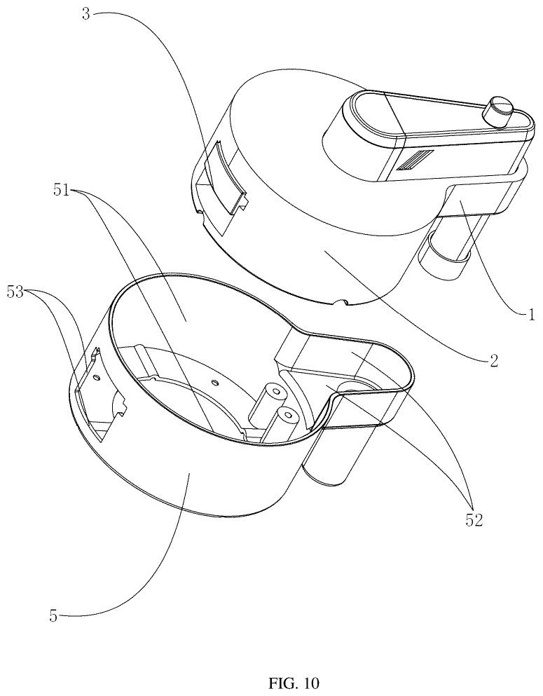

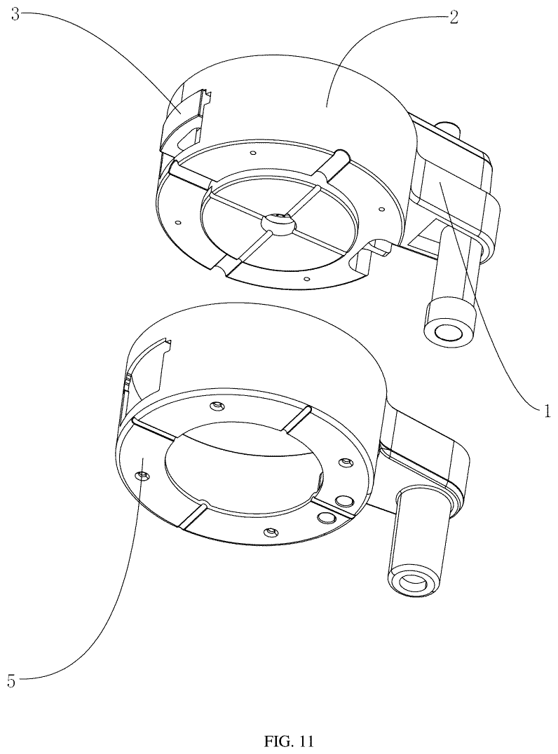

To further maintain the stability of the whole structure of the liquor smoking device, an outer shell part 5 can be further provided. The outer shell part 5 is limited to be made of a metal material, and the outer shell part 5 accommodates the main body part 2 and the handheld part 1, and is provided with an opening at a position corresponding to the movable part 3 so as not to obstruct the movement of the movable part; as long as the outer shell part 5 can support the main body part 2 and the handheld part 1, the specific shape of the outer shell part can be various, for example, a fully enclosed outer shell (the functional position is not enclosed, and the remaining positions are enclosed) or an outer shell with partial side walls and/or top walls and/or bottom walls being enclosed. Preferably, as shown in FIGS. 10 and 11, the outer shell part 5 is provided to be in an upper-end opening shape without a top wall, including an upper-end opening accommodating cavity of the main body part 51 and an upper-end opening accommodating cavity of the handheld part 52, which can save the material, and facilitate the assembly with the main body part 2 and the handheld part 1. A movable part through hole 53 with a proper size is formed at a position corresponding to the movable part 3 to facilitate the entry and exit of the movable part 3. The middle position of the bottom wall of the outer shell part 5 is hollowed out, such that on one hand, the material can be further saved, and on the other hand, a part of the bottom wall of the main body part 2 is exposed, the first smoke outlet 24 directly discharges smoke, and the loss of smoke in the combustion chamber 23 can be reduced. The arrangement of the outer shell part 5 further optimizes the heat insulation effect and avoids the discomfort to the hand caused by the overheating of the main body part 2 during operation. The structure of the outer shell part 5 is preferably as follows. A first groove 81 is formed in the surface of the bottom wall of the main body part 2 and the surface of the bottom wall of the outer shell part 5 on the same straight line, the first groove communicates the surface of the bottom wall of the main body part and the surface of the bottom wall of the outer shell part, and at least one first groove 81 is formed. As shown in FIG. 2, the first groove 81 may be limited to be two, perpendicular to each other; the arrangement of the first groove 81 facilitates the discharge of original air in the liquor glass when the liquor smoking device is placed on the rim of the liquor glass, thereby increasing the volume of smoke entering, increasing the volume of the smoke in the glass, and generating a better smoking effect.

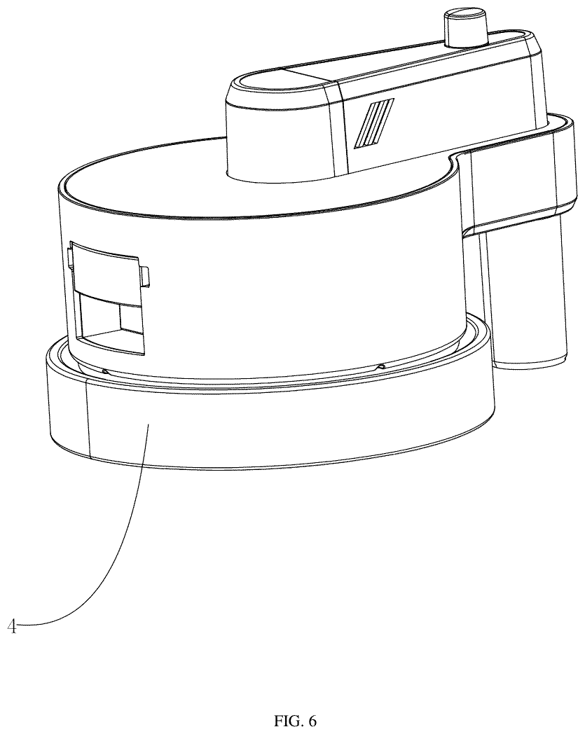

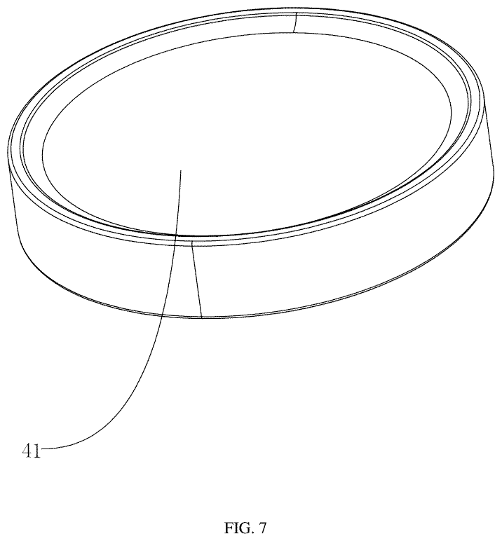

In the case that the length of the handle 11 is longer than the height of the main body part 2, the handle 11 extending downwards will cause the liquor smoking device to be placed unevenly. To solve the problem, in this embodiment, as shown in FIGS. 6 and 7, a base part 4 is further provided, a top wall 41 is provided at the top part of the base part 4, and the top wall 41 can be attached to the bottom wall of the main body part 2 and/or the bottom wall of the outer shell part 5, such that the liquor smoking device is stably and horizontally placed on a horizontal plane. After the base part 4 is added, the lower end surface of the handle 11 is not lower than the lower end surface of the base part 4 in the horizontal state.

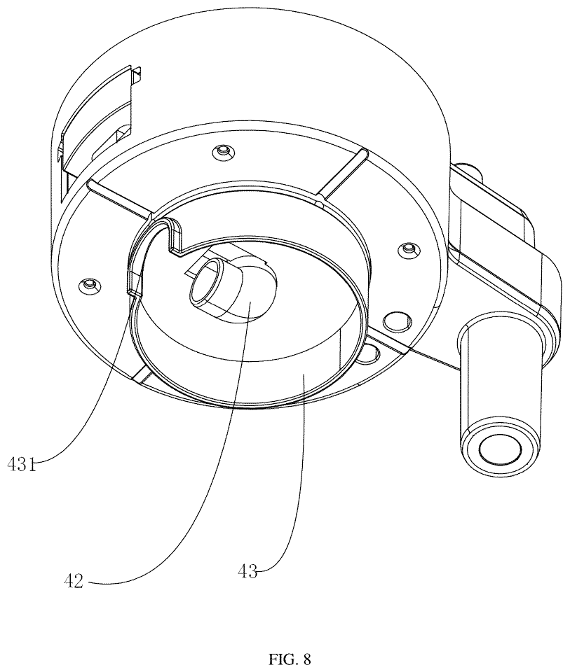

The structure of the liquor smoking device described above is limited by the size of the rim and can only be placed on the glass to discharge smoke downwards, and when the rim is large, the liquor smoking device cannot be used. To solve the problem, as shown in FIGS. 8 to 10, a bent pipe 42 of 90-degree bending is provided in the middle part of the base part 4, the bent pipe 42 is vertically provided with a smoke inlet 421 protruding from the top wall 41, the bent pipe 42 is horizontally provided with a second smoke outlet 422, and the smoke inlet 421 can be inserted into the first smoke outlet 24, such that smoke in the combustion chamber 23 redirects via the bent pipe 42 and is discharged from the second smoke outlet 422. The second smoke outlet 422 can be externally connected to a conduit to guide the smoke discharged in the horizontal direction into the required container, thereby achieving use in more scenarios. Based on this, to further reduce the material cost of the base part 4, the base part 4 may be hollowed out, the edge of the top wall 41 extends downwards to form a side wall 43, no bottom wall is provided, the edge of the lower end of the side wall 43 is in contact with the horizontal plane, a notch 431 is formed in the side wall 43, and the notch 431 can accommodate a pipe to pass through and is connected to the first smoke outlet 24.

From the above description, it can be seen that the above embodiments achieve the following technical effects: The ignition apparatus ignites the wood chips inside without finding an additional fire source; the arrangement of the handheld part facilitates holding by a hand, such that the liquor smoking device is convenient to move and use; the push-and-pull member drives the accommodating groove to enter or exit, such that the high temperature of the combustion groove cannot be transmitted to the hand, and at the same time, wood chips in the combustion groove can be more conveniently replaced or the combustion groove can be directly replaced with. Therefore, the technical solutions of the present application conveniently and quickly solve the technical problems of the holding, replacement, and high-temperature insulation of the liquor smoking device, and on this basis, achieve the technical effects of multiple scenarios, multiple purposes, and low cost, offering enhanced market competitiveness.

The above descriptions are merely exemplary embodiments of the present application and are not intended to limit the protection scope of the present application. The protection scope of the present application is determined by the appended claims.

What is claimed is:

1. A liquor smoking device, comprising:
a handheld part, comprising a handle and an ignition apparatus, wherein the handle is configured to be held by a hand, and the ignition apparatus is configured to generate a flame;
a main body part, wherein the main body part and the handle are spaced apart from each other and provided below the ignition apparatus, a placing cavity is formed inside the main body part, the placing cavity is provided with an opening in a side wall of the main body part, a combustion chamber is formed in a middle part of the placing cavity, first vent holes communicating with the combustion chamber are formed in the side wall of the main body part, and a first smoke outlet communicating with the outside is formed in a bottom wall of the combustion chamber; and
a movable part, wherein the movable part is stably placed in the placing cavity, a front end of the movable part is integrally provided with an accommodating groove penetrating through up and down, a rear end of the movable part is integrally provided with a push-and-pull member for fingers to push and pull out, and the movable part further comprises a combustion groove made of a noncombustible material,
wherein the combustion groove is a U-shaped groove with an upper-end opening and provided with through holes in a bottom wall and a side wall, the combustion groove is capable of disengaging from the accommodating groove, the combustion groove comprises wood chips and is placed in the accommodating groove, the push-and-pull member is pushed to place the movable part in the placing cavity, the combustion groove enters the combustion chamber, the ignition apparatus ignites the wood chips to generate smoke, the smoke is discharged to the outside through the first smoke outlet, the push-and-pull member is pulled to take out the movable part, and the burnt wood chips in the combustion groove is replaced or the combustion groove with new wood chips is directly replaced with.

2. A liquor smoking device according to claim 1, wherein the ignition apparatus comprises a fuel bin provided in the handle, an ignition switch provided at a top part of the handheld part, and an ignition head provided directly above or obliquely above the combustion chamber, wherein the ignition head is connected to second vent holes communicating with the outside, and when the ignition switch is turned on, the ignition head generates a flame to ignite wood chips in the combustion groove.

3. A liquor smoking device according to claim 2, wherein the main body part, the accommodating groove, and the combustion groove all feature cylindrical contours.

4. A liquor smoking device according to claim 3, wherein the push-and-pull member is a square groove formed by concaving a lower half part of an outer side surface of the movable part inwards, and a finger accommodating hole for accommodating fingers is formed upwards in an upper side wall of the square groove.

5. A liquor smoking device according to claim 4, wherein the movable part and the main body part are both made of a wood material, and the combustion groove is made of an iron material.

6. A liquor smoking device according to claim 1, further comprising an outer shell part made of a metal material, wherein the outer shell part accommodates the main body part and the handheld part, and is provided with an opening at a position corresponding to the movable part so as not to obstruct movement of the movable part.

7. A liquor smoking device according to claim 6, wherein a first groove is formed on a surface of a bottom wall of the main body part and a surface of a bottom wall of the outer shell part on a same straight line, the first groove communicates the surface of the bottom wall of the main body part and the surface of the bottom wall of the outer shell part, and at least one first groove is formed.

8. A liquor smoking device according to claim 7, further comprising a base part, wherein a top wall is provided at a top part of the base part, and the top wall is attached to the bottom wall of the main body part and/or the bottom wall of the outer shell part, such that the liquor smoking device is stably and horizontally placed on a horizontal plane.

9. A liquor smoking device according to claim 8, wherein a bent pipe of 90-degree bending is provided in a middle part of the base part, the bent pipe is vertically provided with a smoke inlet protruding from the top wall, the bent pipe is horizontally provided with a second smoke outlet, and the smoke inlet is inserted into the first smoke outlet, such that smoke in the combustion chamber redirects via the bent pipe and is discharged from the second smoke outlet.

10. A liquor smoking device according to claim 9, wherein the base part is hollowed out, an edge of the top wall extends downwards to form a side wall, a notch is formed in the side wall, and the notch accommodates a pipe to pass through and is connected to the first smoke outlet.
